(19) United States
(12) Patent Application Publication
(10) Pub. No.: US 2026/0366631 A1
(43) Pub. Date: Nov. 19, 2026

(54) CHECK VALVE ASSEMBLY FOR VACUUM SYSTEM

(71) Applicant: VTEC CO., LTD., Busan (KR)

(72) Inventor: Ho-Young CHO, Seoul (KR)

(21) Appl. No.: 19/148,262

(22) PCT Filed: Apr. 7, 2023
(86) PCT No.: PCT/KR2023/004742

§ 371 Date: Jul. 15, 2025

(30) Foreign Application Priority Data
Feb. 14, 2023 (KR) 10-2023-0019104

(51) Int. Cl. F16K 15/02

(52) U.S. Cl. CPC F16K 15/028

(57) ABSTRACT

The present invention relates to a check valve assembly for a vacuum system. The vacuum system comprises a vacuum pump having a suction port formed therein and an adsorption pad connected to the side of the suction port, and the assembly of the present invention is attached to the suction port. The assembly comprises: a body including a space formed in a ring-shape recessed in the inner wall of central passage; a check valve which is seated in the space so that a path that is in communication with the passage is formed around the periphery thereof; and a spring which is coaxially arranged in the passage and one end of which presses and supports the check valve.

### TECHNICAL FIELD

The present invention relates to a check valve assembly, and more particularly, to a check valve assembly used together with a vacuum pump in a vacuum system.

### BACKGROUND ART

In general, a ‘vacuum system’ is a device including a vacuum pump that operates by compressed air and an adsorption pad connected to a suction port side of the vacuum pump. When the high-speed compressed air passes through the vacuum pump, internal air of the pad is induced into the vacuum pump through the suction port and then is discharged together with the compressed air to generate a vacuum/negative pressure within the vacuum pump/pad, and thus, an object is adsorbed to the pad by the generated negative pressure. The adsorbed object will be transferred to a designated position by an automated device.

Here, if a diameter of the suction port is too large, a vacuum reaching level is low, and conversely, if the diameter of the suction port is too small, the vacuum reaching speed is slow. Thus, a valve element that is suitably provided in the suction port is required. FIG. 1(a) to 1(c) illustrate a valve assembly 100 and a vacuum system, which are currently manufactured and sold by the applicant, according to a related art.

Referring to FIG. 1(a), the valve assembly 100 includes a through-body 102 that is screw-coupled or bolted to the suction port 101, and a check valve 104 that is installed in a central passage 103 of the body 102 to move vertically within a certain range, and a fine exhaust hole 105 is defined in a center of the check valve 104. In the drawings, reference numeral 109 is a sealing pad. When the vacuum pump 106 operates in a state in which the adsorption pad 107 of the vacuum system is in contact with a surface of an object W, internal air of the pad 107 is discharged momentarily through a path 108 around the check valve 104 and an exhaust hole 105 before the check valve 104 ascends (see arrow \textcircled{1}).

Referring to FIG. 1(b), here, the check valve 104 immediately ascends due to an exhaust air pressure, and thus, the pass 108 is blocked, and the internal air of the pad 107 is discharged only through the exhaust hole 105 (see arrow \textcircled{2}).

As a result, a negative pressure is generated in a sealed internal space S1 of the pad 107, and the object W is adsorbed to the pad 107. Since the internal space S2 of the pad 107 that is not involved in the adsorption of the object W is not sealed, a large amount of outside air may be introduced, and the check valve 104 may ascends due to the introduced air pressure to block the corresponding pass 107, thereby minimizing a vacuum loss of the entire system.

However, the preferred effect of the valve assembly 100 is possible when the assembly 100 is in a state as illustrated in FIGS. (a) and (b), that is, in a relationship of ‘the pad 107 at an upper side and the object at a lower side’, and is impossible in an opposite relationship.

That is, as illustrated in FIG. 1(c), in a state in which the pad 107 is disposed at the lower side, and the object is disposed at the upper side, the check valve 104 falls due to its own weight to block the corresponding pass 107 before the operation, and thus, exhaust of an internal space S of the pad 107 through the pass 107 is impossible from the beginning. In the case in which the positional relationship between the ‘pad 107 and the object W’ is changed frequently due to rotation of the system during the exhaust and transfer, the position or posture of the check valve 104 is also changeable, and thus, the adsorption and transfer operations of the object W may become significantly unstable.

Although not shown, other check valves, such as the so-called ‘ball-type’ check valves, also have the same problem.

### PRIOR ART DOCUMENTS

Korean Utility Model Registration No. 20-0300952
Korean Patent Registration No. 10-1469688
Korean Patent Registration No. 10-0793323
Korean Patent Registration No. 10-1600696

### DISCLOSURE OF THE INVENTION

### Technical Problem

The present invention has been proposed to solve the problems of the above-mentioned conventional valve assembly. An purpose of the present invention is to provide a check valve assembly for a vacuum system, which is capable of rapid exhaust of an adsorption pad and stable adsorption/transfer of an object, regardless of a positional relationship between the ‘pad and the object’ in the vacuum system.

### Technical Solution

A Check Valve Assembly
mounted on a suction port in a vacuum system including an exhaust vacuum pump and an adsorption pad connected to a side of the suction port of the vacuum pump according to the present invention includes:
a body made of a through-material that is fitted into the suction port and including a space configured in a ring shape that is recessed into an inner wall of a central passage;
a check valve, which is a plate-shaped valve having an exhaust hole defined in a central portion thereof, is seated inside the space, and has a path communicating with the passage therearound; and
a spring that is coaxially disposed in the passage and has one end configured to press and elastically support the check valve.

In the above-described structure,
when the vacuum system operates,
in a case in which external air is introduced into the internal space, the check valve may move by a pressure of the introduced air to block the path.

Preferably, the check valve may have
a flow path in a bottom surface thereof,
wherein the flow path may be configured to provide a portion of the path.

In addition,
the spring may have
one end fixed to a side of an end of the passage and the other end that presses the check valve to elastically support a position of the check valve.

Preferably, the body may be
provided by coupling an upper portion to a lower portion,
wherein the space may be defined in a groove shape between the upper portion and the lower portion.

The check valve may include
a recess
into which the other end of the spring is inserted.

### Advantageous Effects

According to the present invention, the check valve may not arbitrarily move within the space due to the spring structure, but move in the direction to block the pass when the large amount of external air is introduced from the pad side, thereby minimizing the vacuum loss in the system. Therefore, regardless of the positional relationship between the pad and the object, there may be the special effect that enables the rapid exhaust of the adsorption pad and the stable adsorption/transport of the object.

### BRIEF DESCRIPTION OF THE DRAWINGS

FIG. 1 (a), (b), and (c) are views for explaining an effect of a conventional valve assembly.

FIG. 2 is a view illustrating an outer appearance of a check valve assembly according to the present invention.

FIG. 3 is a cross-sectional view of FIG. 2.

FIG. 4 is a cross-sectional view illustrating a mounted state of the check valve assembly of FIG. 2.

FIG. 5 is a bottom perspective view illustrating a check valve of the check valve assembly of FIG. 2.

FIG. 6 (a) and (b) are views for explaining an effect of FIG. 4.

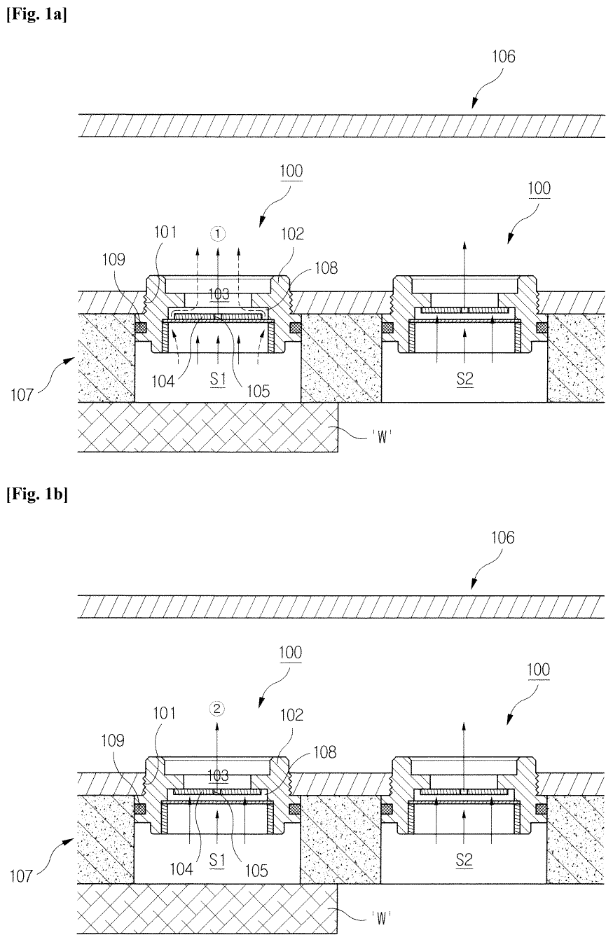

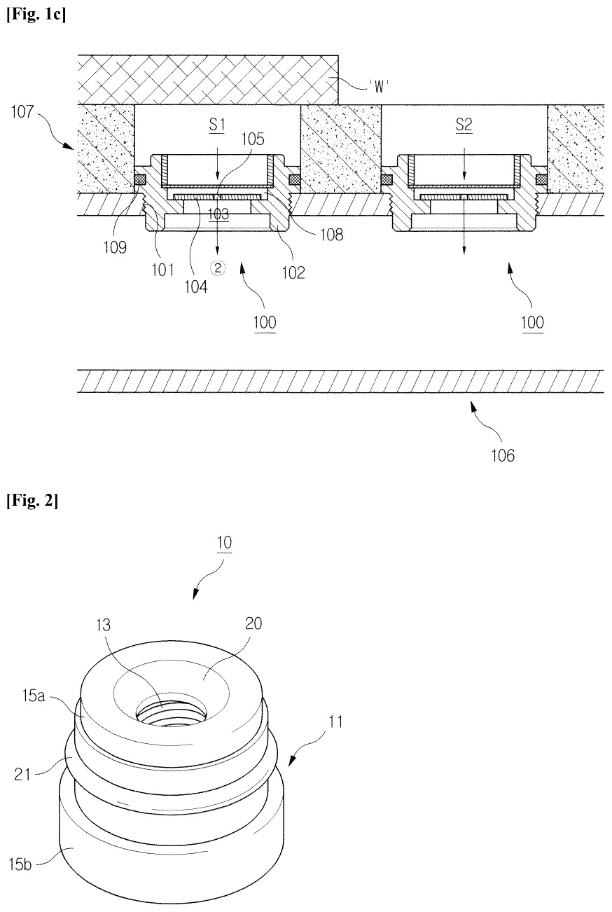

### DESCRIPTION OF THE SYMBOLS

10. Check valve assembly
11. Body
11a. Upper portion 11b. Lower portion
12. Check valve
13. Spring
14. Passage
15. Space
16. Exhaust hole
17. Pass
18. Flow path
19. Recess
20. Inclined surface
21. O-ring
30. Vacuum system
31. Vacuum pump
32. Suction port
33. Pad
34a, 34b. Internal space
W. Object

### Best Mode for Carrying Out the Invention

The features and operational effects of a ‘check valve assembly for a vacuum system’ (hereinafter, ‘referred to as a ‘check valve assembly’) of the present invention, which are described or not described above, will become more apparent through the description of preferred embodiments described below with reference to the attached drawings. In FIG. 2 and below, a check valve assembly of the present invention is indicated by reference numeral ‘10’. In addition, the reference numeral ‘30’ indicates a vacuum system in which the check valve assembly 10 is used.

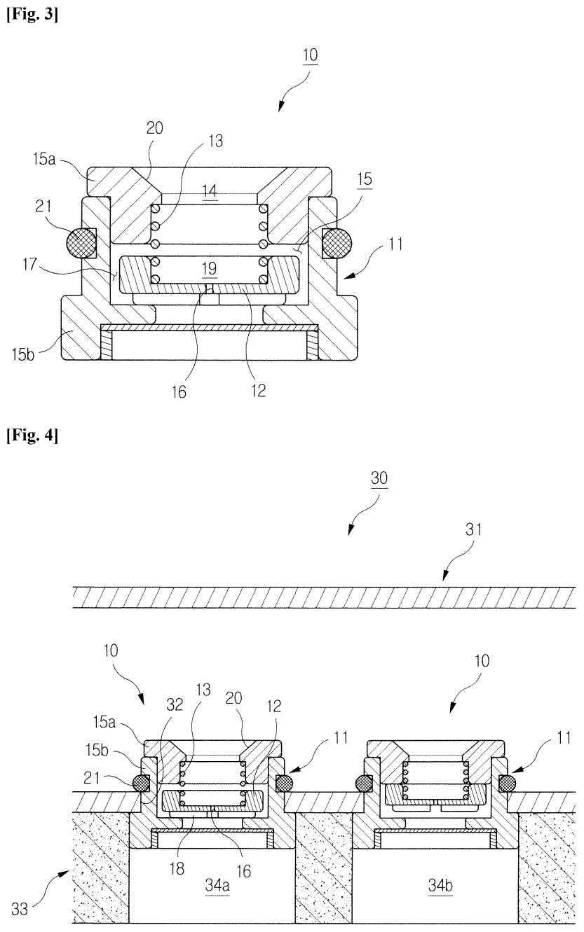

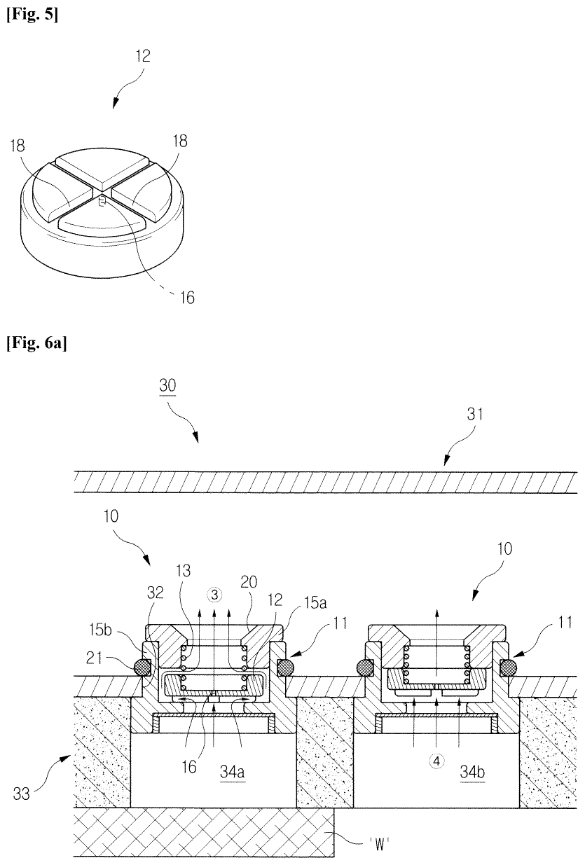

Referring to FIGS. 2 to 4, the check valve assembly 10 of the present invention is a valve assembly that is mounted to be used in a suction port 32 in a vacuum system 30 that includes an exhaust vacuum pump 31 for exhausting air inside a specific space and an absorption pad 33 connected to a side of the suction port 32 of the vacuum pump 31. In this respect, the check valve assembly 10 of the present invention is not different from the conventional check valve assembly.

Depending on a size of the vacuum pump 31, a plurality of suction ports 32 may be provided, and in this case, the check valve assembly 10 may be individually provided in each port 32. In this embodiment, the pad 33 is designed to divide a plurality of spaces 34a and 34b corresponding to the respective ports 32 for a single wide porous material. However, in another embodiments, the pads 33 may be individually provided for the ports 32, respectively.

The check valve assembly 10 of the present invention structurally includes a body 11 that is fitted and fixed to the suction port 32, a check valve 12 disposed inside the body 11, and a spring 13 that supports the check valve 12.

Specifically, the body 11 is made of a through-material that is fitted into the suction port 32 and includes a space 15 configured in a ring shape that is inserted into an inner wall of a central passage 14. Here, the space 15 has to be designed considering its relationship with the check valve 12 disposed therein. Preferably, the body 11 is provided by coupling an upper portionlla to a lower portion 11b. Here, the space 15 is provided in a groove shape between the upper portion 11a and the lower portion 11b. This structure has a feature of making it easy to assemble the entire check valve assembly 10.

In this embodiment, the body 11 may be mounted on the suction port 32 using a sealing and fixing O-ring 21 installed on an outer circumference of an upper end thereof, and thus, separate components for fixing and sealing the body 11 may be omitted.

The check valve 12 is a circular plate with an exhaust hole 16 defined in a center thereof and is seated inside the space 15 as a whole in a manner in which an edge thereof is inserted into a recessed portion of the space 15. Here, a pass 17 communicating with the passage 14 is provided around the check valve 12, that is, between the check valve 12 and the inner wall of the space 15. As a result, relative sizes of the space 15 and the check valve 12 have be designed in consideration of this structure.

Preferably, the check valve 12 has a flow path 18 in a bottom surface (see FIG. 5), and the flow path 18 is provided as a portion of the pass 17 to facilitate a flow of air. In addition, the passage 14 has an expanded inclined surface 20 on an upper end thereof to facilitate the flow of air.

The spring 3 is coaxially disposed within the passage 14 of the body 11, and one end of the spring presses and elastically supports the check valve 12 to prevent the check valve 12 from moving arbitrarily within the space 15.

Specifically, the spring 13 has one end fixed to an end of the passage 14 and the other end that presses the check valve 12 to elastically support a position of the check valve 12.

The check valve 12 includes an recess 19 into which the other end of the spring 13 is inserted. This configuration ensures that the pressing of the spring 13 and the position of the check valve 12 are stably maintained.

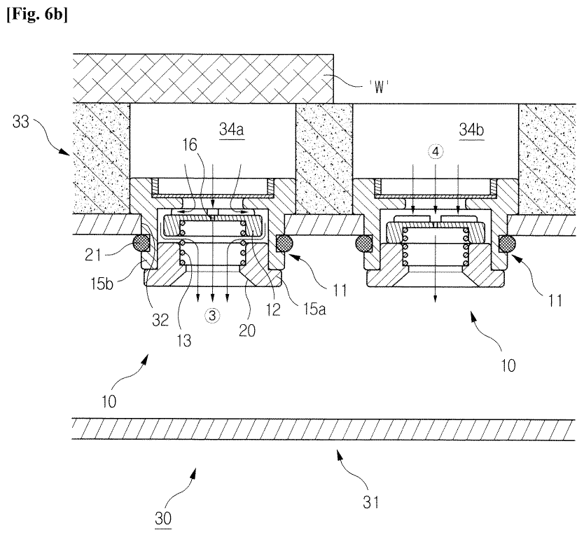

Referring to FIG. 6(a), it may be seen that the check valve assembly 10 of the present invention enables rapid exhaust of the adsorption pad 33 and stable suction/transfer of the object W regardless of the positional relationship between the pad 33 and the object W when the vacuum system 30 is in operation.

The vacuum system 30 operates in a state in which the pad 33 is in contact with a surface of the object w. Specifically, when high-speed compressed air passes through the vacuum pump 31, air in the internal space 34a of the pad 33 passes through the exhaust hole 16 and the pass 17 of the check valve assembly 10 and is induced into the vacuum pump 31 through the passage 14 and discharged to the outside together with the compressed air (see arrow \textcircled{3}). During this exhaust process, a negative pressure is generated in the sealed internal space 34a of the pad 33, and the object W is adsorbed to the pad 33 by the negative pressure generated at this time. In addition, the adsorbed object W will be transferred to a designated location by a separately provided automated device.

Here, since the check valve 12 is supported by the pressure of the spring 13, the check valve 12 does not ascend or move to a level of the pressure of the exhaust air in the internal space 34a of the pad 33, and thus, the pass 17 is not blocked. Therefore, the rapid exhaust of the adsorption pad 33 and the stable adsorption of the object W are possible. In addition, in the event that an unexpected vacuum leakage occurs in the internal space 34a of the pad 33, rapid recovery is possible on its own.

Since the internal space 34b of the pad 33 that is not involved in the adsorption of the object W is not sealed, a large amount of external air is introduced (see arrow \textcircled{4}). In this case, the check valve 12 ascends due to a high pressure of the introduced air to block the corresponding pass 17. In addition, here, since only the micro exhaust hole 16 is opened, the vacuum loss of the entire system 30 may be minimized.

Referring to FIG. 6(b), even if the vacuum system 30 rotates at an angle of 180° in the above-described state (a), and thus, the positional relationship between the ‘pad 33 and the object W’ is changed ‘from a position of ‘the upper side and the lower’ to a position of ‘the lower side and the upper side’ or changed at another angle, the system 30 may be maintained in the same function as (a) described above. This is because the position of the check valve 12 is supported by an appropriate pressure by the structure of the spring 13.

1. A check valve assembly mounted on a suction port (32) in a vacuum system (30) comprising an exhaust vacuum pump (31) and an adsorption pad (33) connected to a side of the suction port (32) of the vacuum pump (31), the check valve assembly comprising:
a body made of a through-material that is fitted into the suction port (32) and comprising a space (15) configured in a ring shape that is recessed into an inner wall of a central passage (14) ;
a check valve (12), which is a plate-shaped valve having an exhaust hole (16) defined in a central portion thereof, is seated inside the space (15), and has a path (17) communicating with the passage (14) therearound; and
a spring (13) that is coaxially disposed in the passage (14) and has one end configured to press and elastically support the check valve (12).

2. The check valve assembly of claim 1, wherein, when the vacuum system (30) operates, in a case in which external air is introduced into the internal space (34b), the check valve (12) moves by a pressure of the introduced air to block the path (17).

3. The check valve assembly of claim 1, wherein the check valve (12) has a flow path (18) in a bottom surface thereof,
wherein the flow path (18) is configured to provide a portion of the path (17).

4. The check valve assembly of claim 1, wherein the spring has one end fixed to a side of an end of the passage (14) and the other end that presses the check valve (12) to elastically support a position of the check valve (12).

5. The check valve assembly of claim 1, wherein the body (11) is provided by coupling an upper portion (11a) to a lower portion (11b),
wherein the space (15) is defined in a groove shape between the upper portion (11a) and the lower portion (11b).

6. The check valve assembly of claim 1, wherein the check valve (12) comprises a recess (19) into which the other end of the spring (13) is inserted.

7. The check valve assembly 44 wherein the passage (14) has an expanded inclined surface (20) on an upper end thereof.

8. The check valve assembly of claim 1, wherein the body (11) is mounted on the suction port (32) using a sealing and fixing O-ring (21) installed on an outer circumference of an upper end thereof.
